(19) United States
(12) Patent Application Publication
(10) Pub. No.: US 2019/0329790 A1
(43) Pub. Date: Oct. 31, 2019

(54) Systems and Methods for Using Machine Learning to Determine Passenger Ride Experience

(71) Applicant: Uber Technologies, Inc., San Francisco, CA (US)

(72) Inventor: Anand Nandakumar, Huntington Beach, CA (US)

(21) Appl. No.: 15/975,265

(22) Filed: May 9, 2018

Related U.S. Application Data
(60) Provisional application No. 62/662,388, filed on Apr. 25, 2018.

(51) Int. Cl. B60W 50/00; G05D 1/00; G05D 1/02; G06N 99/00

(52) U.S. Cl. CPC B60W 50/0098; G05D 1/0088; G05D 1/0212; B60W 2050/0014; G05D 2201/0212; G05D 2201/0213; B60W 2540/22; G06N 99/005

(57) ABSTRACT

Systems and methods are directed to using machine learning to determine passenger ride experience. In one example, a computer-implemented method includes receiving, by a computing system comprising one or more computing devices, sensor data from one or more sensors positioned within a cabin of a vehicle, the sensor data being descriptive of one or more passengers located within the cabin of the vehicle. The method further includes inputting, by the computing system, the sensor data to a machine-learned ride experience model and receiving, as an output of the machine-learned ride experience model, ride experience data including ride experience events detected from the sensor data and a classification for each detected ride experience event according to a ride experience rating. The method further includes determining, by the computing system and based on the ride experience rating for each detected ride experience event, a ride experience control signal associated with operation of the vehicle.

The present application is based on and claims the benefit of U.S. Provisional Application 62/662,388 having a filing date of Apr. 25, 2018, which is incorporated by reference herein.

### FIELD

The present disclosure relates generally to operation of an autonomous vehicle. More particularly, the present disclosure relates to systems and methods that provide for using machine learning to detect passenger ride experience events and to classify detected events according to a ride experience rating.

### BACKGROUND

An autonomous vehicle is a vehicle that is capable of sensing its environment and navigating with little to no human input. In particular, an autonomous vehicle can observe its surrounding environment using a variety of sensors and can attempt to comprehend the environment by performing various processing techniques on data collected by the sensors. This can allow an autonomous vehicle to navigate without human intervention and, in some cases, even omit the use of a human driver altogether.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method for determining passenger ride experience. The method includes receiving, by a computing system comprising one or more computing devices, sensor data from one or more sensors positioned within a cabin of a vehicle, the sensor data being descriptive of one or more passengers located within the cabin of the vehicle. The method further includes inputting, by the computing system, the sensor data to a machine-learned ride experience model. The method further includes receiving, by the computing system as an output of the machine-learned ride experience model, ride experience data including ride experience events detected from the sensor data and a classification for each detected ride experience event according to a ride experience rating. The method further includes determining, by the computing system and based on the ride experience rating for each detected ride experience event, a ride experience control signal associated with operation of the vehicle.

Another example aspect of the present disclosure is directed to a computing system. The computing system includes one or more image sensors positioned within a cabin of a vehicle and configured to obtain image data being descriptive of an appearance of one or more passengers located within the cabin of the vehicle; one or more processors; a machine-learned ride experience model that has been trained to analyze the image data by implementing facial expression analysis and body pose analysis of the image data and to generate ride experience data in response to receipt of the image data; and at least one tangible, non-transitory computer readable medium that stores instructions that, when executed by the one or more processors, cause the one or more processors to perform operations. The operations include providing real-time samples of the image data to the machine-learned ride experience model. The operations further include receiving as an output of the machine-learned ride experience model, ride experience data including ride experience events detected from the image data and a classification for each detected ride experience event according to a ride experience rating.

Another example aspect of the present disclosure is directed to an autonomous vehicle. The autonomous vehicle includes a sensor system comprising one or more image sensors and one or more audio sensors for obtaining respective image data and audio data associated with one or more passengers of an autonomous vehicle and a vehicle computing system. The vehicle computing system includes one or more processors; and at least one tangible, non-transitory computer readable medium that stores instructions that, when executed by the one or more processors, cause the one or more processors to perform operations. The operations include inputting the image data and audio data to a machine-learned ride experience model. The operations further include receiving, as an output of the machine-learned ride experience model, ride experience data including ride experience events detected from the sensor data and a classification for each detected ride experience event according to a ride experience rating. The operations further include determining, based on the ride experience rating for each detected ride experience event, a ride experience control signal associated with operation of the vehicle.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example system for controlling the navigation of a vehicle according to example embodiments of the present disclosure;

FIG. 2 depicts a block diagram of an example machine-learned ride experience model according to example embodiments of the present disclosure;

FIG. 3 depicts a block diagram of an example ride experience control system according to example embodiments of the present disclosure;

FIGS. 4 and 5 depict example portions of image data and objects of interest determined by a ride experience model according to example embodiments of the present disclosure;

FIGS. 6 and 7 depict example portions of image data and body connection frameworks determined by a ride experience model according to example embodiments of the present disclosure;

FIG. 8 depicts a flowchart diagram of an example method of determining passenger ride experience according to example embodiments of the present disclosure;

FIG. 9 depicts a flowchart diagram of an example method of analyzing body pose as part of determining passenger ride experience according to example embodiments of the present disclosure;

FIG. 10 depicts a flowchart diagram of an example method of training a machine-learned ride experience model according to example embodiments of the present disclosure; and

FIG. 11 depicts a block diagram of an example computing system according to example embodiments of the present disclosure.

### DETAILED DESCRIPTION

Reference now will be made in detail to embodiments, one or more example(s) of which are illustrated in the drawings. Each example is provided by way of explanation of the embodiments, not limitation of the present disclosure. In fact, it will be apparent to those skilled in the art that various modifications and variations can be made to the embodiments without departing from the scope of the present disclosure. For instance, features illustrated or described as part of one embodiment can be used with another embodiment to yield a still further embodiment. Thus, it is intended that aspects of the present disclosure cover such modifications and variations.

Generally, the present disclosure is related to using machine learning to detect passenger ride experience events and to classify detected events according to a ride experience rating. More particularly, a vehicle such as but not limited to an autonomous vehicle can include one or more sensors positioned within a vehicle cabin and configured to obtain sensor data (e.g., image data and/or audio data) associated with one or more passengers of the vehicle. A machine-learned ride experience model can be trained to receive the sensor data as input, and in response to receipt of the image and/or audio data, generate ride experience data as output. The machine-learned ride experience model can have been trained to learn which facial expressions, body gestures and/or passenger sounds identified from the image data and/or audio data correspond to ride experience events. The ride experience model can have been further trained to classify detected ride experience events according to a ride experience rating. The resultant ride experience data output by the machine-learned ride experience model, including ride experience event detections and/or associated ride experience ratings, can thus provide real-time and/or historical information that can be used to improve the passenger ride experience.

More particularly, in some implementations, passenger ride experience can be determined for a variety of different types of vehicles. In some implementations, passenger ride experience can be determined for a ground-based vehicle (e.g., an automobile), an aircraft, and/or another type of vehicle. In some implementations, the vehicle can be an autonomous vehicle that can perform various actions including driving, navigating, and/or operating, with minimal and/or no interaction from a human driver. The autonomous vehicle can be configured to operate in one or more modes including, for example, a fully autonomous operational mode, a semi-autonomous operational mode, a park mode, and/or a sleep mode. A fully autonomous (e.g., self-driving) operational mode can be one in which the vehicle can provide driving and navigational operation with minimal and/or no interaction from a human driver present in the vehicle. A semi-autonomous operational mode can be one in which the vehicle can operate with some interaction from a human driver present in the vehicle. Park and/or sleep modes can be used between operational modes while the vehicle performs various actions including waiting to provide a subsequent vehicle service, and/or recharging between operational modes.

A vehicle for which passenger ride experience is determined can include a cabin in which one or more passengers can be positioned for transport between locations (e.g., among one or more start destinations and one or more end destinations). The passenger cabin can include one or more passenger sensors that are configured to obtain sensor data associated with the one or more passengers. For example, one or more image sensors (e.g., cameras and the like) can be positioned within a cabin of a vehicle and configured to obtain image data descriptive of one or more passengers located within the cabin of the vehicle. Similarly, one or more audio sensors (e.g., microphones and the like) can be positioned within the cabin of the vehicle and configured to obtain audio data descriptive of one or more passengers located within the cabin of the vehicle. Image sensors and/or audio sensors can be provided in a variety of locations within the vehicle cabin, including but not limited to on the vehicle dash, in an overhead location within the cabin, and/or on interior doors or windows of a vehicle, or other positions configured to obtain image data of passenger faces and bodies and audio data of passenger sounds. It should be appreciated that vehicles, services, and/or applications that gather sensor data as described herein can be configured with options for permissions to be obtained from vehicle passengers before such sensor data is collected for authorized use in accordance with the disclosed techniques.

The passenger sensor data can be obtained and provided as input to a machine-learned ride experience model that is trained to determine ride experience data in response to receiving the sensor data as input. In some implementations, the machine-learned ride experience model is configured to implement one or more of facial expression analysis, body pose analysis, and sound analysis. A combination of one or more types of analysis can be used to determine ride experience data that is based in part on the facial expression analysis, body pose analysis, and/or sound analysis. Ride experience data can include, for example, ride experience event detections and/or ride experience ratings associated with the event detections.

For example, a ride experience rating can classify each detected ride experience event by selecting from a predetermined class of events (e.g., a good passenger experience event and a bad passenger experience event). Additionally or alternatively, a ride experience rating can classify each detected ride experience event by dynamically determining the ride experience rating on a gradient scale within a range of possible values (e.g., a scale from 0-10).

In some embodiments, the machine-learned ride experience model can include various models, for example, neural networks (e.g., deep neural networks), support vector machines, decision trees, ensemble models, k-nearest neighbors models, Bayesian networks, or other types of models including linear models and/or non-linear models. Example neural networks include feed-forward neural networks, convolutional neural networks, recurrent neural networks (e.g., long short-term memory recurrent neural networks), or other forms of neural networks.

When the machine-learned ride experience model is configured to implement facial expression analysis, image data can be analyzed by one or more facial expression layers within the machine-learned ride experience model. The machine-learned ride experience model can be trained to analyze the entire canvas of each passenger's face as detected within image data from the one or more passenger sensors and to correlate the facial expression of each passenger with a predetermined type of ride experience event and/or rating. For example, instead of using hand-crafted rules or detailed algorithms for analyzing different facial expressions and/or micro-expressions, training data can configure the machine-learned ride experience model to identify when certain facial expressions correspond to a “good” ride experience event, a “bad” ride experience event, and/or a gradient rating associated with the overall ride experience at the time the sensor data was obtained. The set of training data can include a variety of facial expression samples that encompass a wide range of facial features including different eye positions, eyebrow positions, mouth positions, face wrinkling, and/or other facial gestures that would correspond to the different passenger experience event types and/or ratings.

When the machine-learned ride experience model is configured to implement body pose analysis, image data can be analyzed by one or more body pose layers within the machine-learned ride experience model. The machine-learned ride experience model can be trained to analyze at least a portion of each passenger's body as detected within image data from the one or more passenger sensors and to correlate body pose of each passenger with a predetermined type of ride experience event and/or rating. For example, instead of using hand-crafted rules or detailed algorithms for analyzing different body poses and/or gestures, training data can configure the machine-learned ride experience model to identify when certain body poses correspond to a “good” ride experience event, a “bad” ride experience event, and/or a gradient rating associated with the overall ride experience at the time the sensor data was obtained. The set of training data can include a variety of body pose samples that encompass a wide range of poses including comfortable poses, uncomfortable poses, and/or other body poses and/or gestures that would correspond to the different passenger experience event types and/or ratings.

In some particular implementations, as part of analyzing facial expression and/or body pose, the machine-learned ride experience model can be configured to detect one or more objects of interest within a vehicle cabin. Objects of interest can include, but are not limited to passengers, phones, weapons, etc. For each detected passenger, the machine-learned ride experience model can further detect one or more body parts associated with the one or more passengers located within the cabin of the vehicle. For facial analysis, the body parts can include top, bottom, and/or sides of face, one or more eye(s), one or more eyebrow(s), mouth position and/or shape, and the like. In some implementations, the machine-learned ride experience model can be configured to determine a facial connection framework (e.g., an assembly of one or more line segments connecting selected body parts together) connecting multiple of the one or more body parts together and to implement facial expression analysis by measuring relative movement of the facial connection framework. For body pose analysis, the body parts can include head, shoulders, neck, eyes, and the like. In some implementations, the machine-learned ride experience model can be configured to determine a body connection framework (e.g., an assembly of one or more line segments connecting selected body parts together) connecting multiple of the one or more body parts together and to implement body pose analysis by measuring relative movement of the body connection framework from one time frame to the next.

When the machine-learned ride experience model is configured to implement sound analysis, audio data can be analyzed according to one or more sound layers within the machine-learned ride experience model. The machine-learned ride experience model can be trained to analyze at least a portion of each passenger's sound (e.g., words, noises, absence of sound, or other passenger utterances) as detected within audio data from the one or more passenger sensors and to correlate sound from each passenger with a predetermined type of ride experience event and/or rating. For example, instead of using hand-crafted rules or detailed algorithms for analyzing different sounds, training data can configure the machine-learned ride experience model to identify when certain passenger sounds correspond to a “good” ride experience event, a “bad” ride experience event, and/or a gradient rating associated with the overall ride experience at the time the sensor data was obtained. The set of training data can include a variety of sound samples that encompass a wide range of sounds including most favorable sounds and/or least favorable sounds and those in between that would correspond to the different passenger experience event types and/or ratings.

According to another aspect of the present disclosure, in some implementations, the machine-learned ride experience model can be configured to output a single type or multiple types of ride experience data. For example, ride experience data can include ride experience events detected from the sensor data and a classification for each detected ride experience event according to a ride experience rating. Ride experience events can be selected from a predetermined class of ride experience event types (e.g., a good passenger experience event, a bad passenger experience event). In other embodiments, the ride experience rating can be dynamically determined within a range of values (e.g., a score determined within a range from 0 to 10, with 0 corresponding to a least favorable level of passenger experience and 10 corresponding to a most favorable level of passenger experience).

In some implementations, ride experience data can include a warning signal that indicates a detected emergency situation based on analysis by the machine-learned ride experience model. For example, detection of facial expressions and/or body poses could indicate an emergency health issue (e.g., a panic attack, heart attack, seizure, stroke, etc.). Detection of certain objects in the cabin of the vehicle (e.g., a weapon) could indicate an emergency safety issue. As such, in some implementations, the machine-learned ride experience model can be trained such that the ride experience data includes a warning signal indication when such special circumstances are detected from the passenger sensor data.

In some instances, the machine-learned ride experience model can have been trained to output ride experience data that includes combined analysis of multiple sensor data aspects (e.g., facial expression and body pose, or facial expression and sound, or body pose and sound, or facial expression and body post and sound). In such instances, the machine-learned ride experience model can include a first portion of layers including one or more layers (e.g., facial expression layers, body pose layers, sound layers, etc.) that are respectively dedicated to different portions of such analysis. The machine-learned ride experience model can also include a second portion of layers that are positioned structurally after the first portion of layers and that include one or more shared layers. The second portion of layers that include the one or more shared layers can combine analysis from the different and distinct first portion of layers to determine how the different types of analysis (e.g., facial expression analysis, body pose analysis, sound analysis, etc.) combine in determining ride experience data that characterizes the overall ride experience of one or more passengers. In some implementations, the first portion of layers can also include some shared layers (e.g., those layers dedicated to analyzing image data that apply to both facial expression analysis and body pose analysis).

By providing a machine-learned model that has been trained to analyze multiple joint variables, improved determination of some variables (e.g., facial expressions, body poses, sounds, etc.) can lead to improved determination of ride experience data as a whole. For example, improved determination of facial expressions can help improve a detected class of passenger experience event type. By co-training a machine-learned model across multiple desired factors (e.g., multiple types of sensor data analysis), an efficient model can be utilized. In addition, by providing ride experience control that is dependent on multiple parameters, the disclosed technology can provide more comprehensive analysis and improvement of the ride experience.

According to another aspect of the present disclosure, ride experience data generated by the disclosed machine-learned ride experience model can be provided alone or in combination with other types of data to a ride experience controller. In some implementations, additional data provided to the ride experience controller can include trip data that identifies one or more states of the vehicle in which the passengers are traveling. For instance, trip data can include one or more positions of the vehicle, locations of the vehicle, velocities of the vehicle, accelerations of the vehicle, events associated with movement of the vehicle (e.g., predetermined types of events such as jerks, jukes, kickouts, etc.) In some implementations, additional data provided to the ride experience controller can include user feedback data, for example, data provided directly by the one or more passengers indicating their feedback regarding the ride experience (e.g., a good ride experience, a ride experience rated 7.5 on a scale of 1-10, a desire to stop the ride, etc.).

The ride experience controller can receive the ride experience data (along with additional optional data such as but not limited to trip data and/or user feedback data). When multiple portions of data are received, the ride experience controller can correlate such data across time and/or trip distance so that the ride experience data, trip data, and/or user feedback data associated with a single moment can all be analyzed collectively. As such, if ride experience data indicates a bad experience based on passenger facial expressions (e.g., grimacing face) at time t, and trip data indicates a sharp braking at the same time t (or within a threshold time difference from time t), then the ride experience controller is able to identify and leverage when different portions of data all point to a similar type of passenger experience.

Based on correlation and analysis by the ride experience controller, the ride experience controller can determine one or more ride experience control signals associated with operation of the vehicle as output. In some implementations, a ride experience control signal can include one or more of a vehicle control signal, a driving data log signal, and/or a trip assistance signal.

A vehicle control signal can include a signal that is directed to a vehicle controller that controls one or more vehicle controls (e.g., actuators or other devices that control gas flow, steering, braking, etc.). In some implementations (e.g., those involving autonomous vehicles), the vehicle control signal can be provided to or through a vehicle autonomy system that is configured to generate a motion plan for autonomously navigating the vehicle through its environment. In such instances, the vehicle control signal can provide for adjusting the motion plan of a vehicle according to ride experience data, for example, to speed up, slow down, stop, etc. as appropriate.

In some implementations, a driving data log signal can include a control signal that triggers storage of data associated with a detected ride experience event. For example, if passenger sensor data is obtained and stored only temporarily in a memory buffer, then a driving data log signal can be generated that controls the memory buffer to transfer sensor data and/or ride experience data associated with detected ride experience events to a permanent memory for subsequent analysis. In some implementations, the driving data log signal can include a control signal that triggers updating of a ride experience event counter and/or related information. Updating of a ride experience event counter can help determine other metrics associated with overall passenger ride experience such as a total number of good and/or bad experiences, number of miles since last bad experience, or other parameters that can be indicative of the overall ride experience for a passenger, trip, or vehicle.

In some implementations, a trip assistance signal can include a control signal that is transmitted to a location remote from the vehicle. The trip assistance signal can include a request to initiate two-way conversation with the vehicle (e.g., with passengers located within the cabin of the vehicle) to facilitate further communication and determination of subsequent assistance steps. Subsequent assistance steps can include, for example, slowing of the vehicle, stopping of the vehicle, rerouting of the vehicle, transmission of third party aid to the current location or predicted future location of the vehicle, etc.

In some implementations, when training the machine-learned ride experience model to analyze image data and/or audio data associated with vehicle passengers and generate ride experience data, a ride experience training dataset can include a large number of previously obtained representations of sensor data and corresponding labels that describe corresponding ride experience data (e.g., particular ride experience events and/or ride experience ratings) associated with the corresponding sensor data.

In one implementation, the training dataset can include a first portion of data corresponding to one or more representations of sensor data (e.g., image data and/or audio data) originating from sensors within the cabin of a vehicle. The sensor data can, for example, be recorded while a vehicle is in navigational operation. The training dataset can further include a second portion of data corresponding to labels identifying ride experience events and/or ratings associated with detected events. The labels included within the second portion of data within the training dataset can be manually annotated, automatically annotated, or annotated using a combination of automatic labeling and manual labeling.

In some implementations, to train the ride experience model, a training computing system can input a first portion of a set of ground-truth data (e.g., the first portion of the training dataset corresponding to the one or more representations of sensor data) into the machine-learned ride experience model to be trained. In response to receipt of such first portion, the machine-learned ride experience model outputs detected ride experience events and associated ride experience ratings. This output of the machine-learned ride experience model predicts the remainder of the set of ground-truth data (e.g., the second portion of the training dataset). After such prediction, the training computing system can apply or otherwise determine a loss function that compares the ride experience event detections and associated ratings output by the machine-learned ride experience model to the remainder of the ground-truth data (e.g., ground-truth labels) which the ride experience model attempted to predict. The training computing system then can backpropagate the loss function through the ride experience model to train the ride experience model (e.g., by modifying one or more weights associated with the ride experience model). This process of inputting ground-truth data, determining a loss function, and backpropagating the loss function through the ride experience model can be repeated numerous times as part of training the ride experience model. For example, the process can be repeated for each of numerous sets of ground-truth data provided within the ride experience training dataset.

In accordance with another aspect of the present disclosure, when a vehicle is an autonomous vehicle, it can include an autonomy sensor system, which includes different sensors than the passenger sensors positioned within the vehicle cabin for obtaining image data and/or audio data associated with the passenger(s). More particularly, an autonomy sensor system can include one or more autonomy sensors configured to generate and/or store autonomy sensor data associated with one or more objects that are proximate to the vehicle (e.g., within range or a field of view of one or more of the one or more sensors). The one or more autonomy sensors can include a Light Detection and Ranging (LIDAR) system, a Radio Detection and Ranging (RADAR) system, one or more cameras (e.g., visible spectrum cameras and/or infrared cameras), motion sensors, and/or other types of imaging capture devices and/or sensors.

An autonomous vehicle can also include a vehicle computing system. The vehicle computing system can include one or more computing devices and one or more vehicle controls. The one or more computing devices can include a perception system, a prediction system, and a motion planning system that cooperate to perceive the surrounding environment of the autonomous vehicle and determine a motion plan for controlling the motion of the autonomous vehicle accordingly. The vehicle computing system can receive autonomy sensor data from the autonomy sensor system as described above and utilize such autonomy sensor data in the ultimate motion planning of the autonomous vehicle.

The perception system can identify one or more objects that are proximate to the autonomous vehicle based on autonomy sensor data received from the autonomy sensor system. In particular, in some implementations, the perception system can determine, for each object, state data that describes a current state of such object. As examples, the state data for each object can describe an estimate of the object's: current location (also referred to as position); current speed; current heading (which may also be referred to together as velocity); current acceleration; current orientation; size/footprint (e.g., as represented by a bounding shape such as a bounding polygon or polyhedron); class of characterization (e.g., vehicle versus pedestrian versus bicycle versus other); yaw rate; and/or other state information. In some implementations, the perception system can determine state data for each object over a number of iterations. In particular, the perception system can update the state data for each object at each iteration. Thus, the perception system can detect and track objects (e.g., vehicles, bicycles, pedestrians, etc.) that are proximate to the autonomous vehicle over time, and thereby produce a presentation of the world around an autonomous vehicle along with its state (e.g., a presentation of the objects of interest within a scene at the current time along with the states of the objects).

The prediction system can receive the state data from the perception system and predict one or more future locations and/or moving paths for each object based on such state data. For example, the prediction system can predict where each object will be located within the next 5 seconds, 10 seconds, 20 seconds, etc. As one example, an object can be predicted to adhere to its current trajectory according to its current speed. As another example, other, more sophisticated prediction techniques or modeling can be used.

The motion planning system can determine a motion plan for the autonomous vehicle based at least in part on one or more predicted future locations and/or moving paths for the object and/or the state data for the object provided by the perception system. Stated differently, given information about the current locations of objects and/or predicted future locations and/or moving paths of proximate objects, the motion planning system can determine a motion plan for the autonomous vehicle that best navigates the autonomous vehicle along the determined travel route relative to the objects at such locations.

As one example, in some implementations, the motion planning system can determine a cost function for each of one or more candidate motion plans for the autonomous vehicle based at least in part on the current locations and/or predicted future locations and/or moving paths of the objects. For example, the cost function can describe a cost (e.g., over time) of adhering to a particular candidate motion plan. For example, the cost described by a cost function can increase when the autonomous vehicle approaches impact with another object and/or deviates from a preferred pathway (e.g., a predetermined travel route).

Thus, given information about the current locations and/or predicted future locations and/or moving paths of objects, the motion planning system can determine a cost of adhering to a particular candidate pathway. The motion planning system can select or determine a motion plan for the autonomous vehicle based at least in part on the cost function(s). For example, the motion plan that minimizes the cost function can be selected or otherwise determined. The motion planning system then can provide the selected motion plan to a vehicle controller that controls one or more vehicle controls (e.g., actuators or other devices that control gas flow, steering, braking, etc.) to execute the selected motion plan.

The systems and methods described herein may provide a number of technical effects and benefits. By detecting the occurrence of passenger ride experience events based on audio/visual feedback directly from passengers, a ride experience control system can more comprehensively evaluate passenger ride experience for vehicles, especially autonomous vehicles. Accuracy of ride experience data can be improved by training a machine-learned ride experience model to implement multiple layers of analysis, including facial expression analysis, body pose analysis, sound analysis, etc. By coupling this improved ride experience data with other data including trip data and/or user feedback data, ride control signals can be determined that better identify and evaluate passenger ride experience across the board. When a greater number of passenger ride experience events are detected and/or when ride experience ratings better reflect the true nature of the overall passenger ride experience, greater opportunities are presented to improve the quality, comfort, and safety of trips for passengers.

Accordingly, a vehicle can be configured to avoid the types of vehicle actions (e.g., hard left turns) that result in unfavorable passenger experiences. Additionally, better identification of vehicle states that result in passenger discomfort can in some instances result in more effective use of vehicle systems. For example, passenger comfort may be associated with a range of accelerations that is lower and potentially more fuel efficient. As such, lower acceleration can result in both fuel savings and greater passenger comfort.

Further, the disclosed technology can also more optimally determine the occurrence of an unfavorable experience by a passenger, which can be used to reduce the number of vehicle stoppages due to passenger discomfort. For example, a passenger in a vehicle that does not use ride experience data to adjust its performance (e.g., acceleration and/or turning) can be more prone to request vehicle stoppage, which can result in less efficient use of energy that results from more frequent acceleration following a vehicle stoppage. As such, reducing the number of stoppages of a vehicle due to passenger discomfort can result in more efficient energy usage through decreased occurrences of accelerating the vehicle from a stop.

Furthermore, the disclosed technology can improve the longevity of the vehicle's components by determining vehicle states that correspond to an unfavorable experience for a passenger of the vehicle and generating data that can be used to moderate the vehicle states that strain vehicle components and cause an unfavorable experience for the passenger. For example, sharp turns that accelerate wear and tear on a vehicle's wheels and steering components can correspond to an unfavorable experience for a passenger. By generating data indicating a less sharp turn for the passenger, the vehicle's wheels and steering components can undergo less strain and last longer.

Accordingly, the disclosed technology can provide more effective determination of an unfavorable ride experience through improvements in passenger safety, energy conservation, passenger comfort, and vehicle component longevity, as well as allowing for improved performance of other vehicle systems that can benefit from a closer correspondence between a passenger's comfort and the vehicle's state.

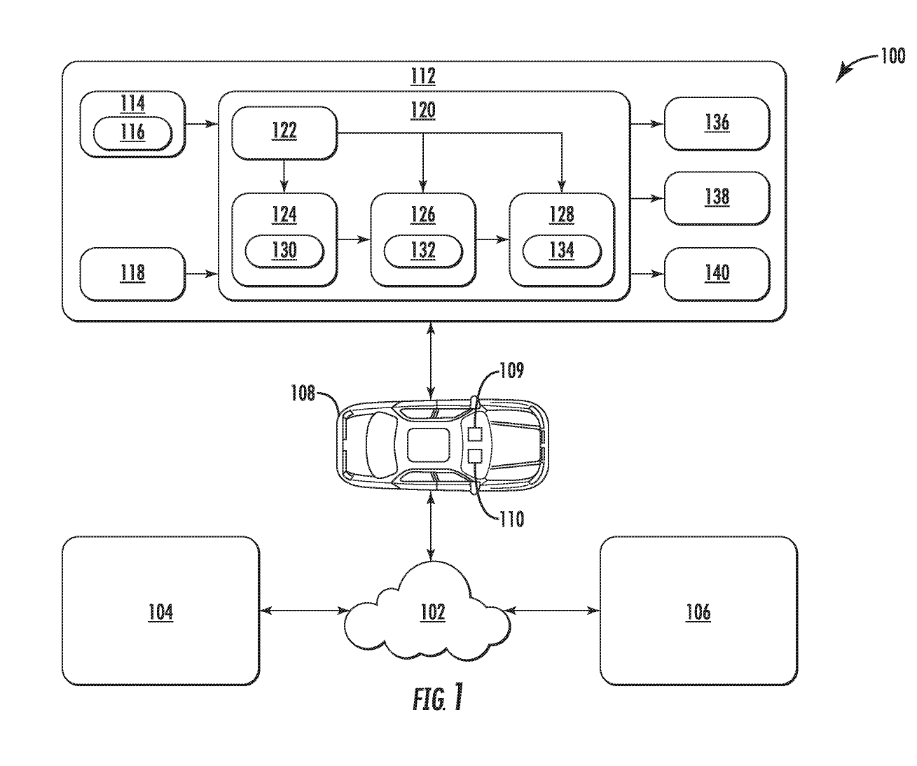

FIG. 1 depicts a block diagram of an example system 100 for controlling the navigation of a vehicle according to example embodiments of the present disclosure. As illustrated, FIG. 1 shows a system 100 that includes a communication network 102; an operations computing system 104; one or more remote computing devices 106; a vehicle 108; one or more passenger compartment image sensors 109; one or more passenger compartment audio sensors 110; a vehicle computing system 112; one or more autonomy system sensors 114; autonomy system sensor data 116; a positioning system 118; an autonomy computing system 120; map data 122; a perception system 124; a prediction system 126; a motion planning system 128; state data 130; prediction data 132; motion plan data 134; a communication system 136; a vehicle control system 138; and a human-machine interface 140.

The operations computing system 104 can be associated with a service provider that can provide one or more vehicle services to a plurality of users via a fleet of vehicles that includes, for example, the vehicle 108. The vehicle services can include transportation services (e.g., rideshare services), courier services, delivery services, and/or other types of services.

The operations computing system 104 can include multiple components for performing various operations and functions. For example, the operations computing system 104 can include and/or otherwise be associated with the one or more computing devices that are remote from the vehicle 108. The one or more computing devices of the operations computing system 104 can include one or more processors and one or more memory devices. The one or more memory devices of the operations computing system 104 can store instructions that when executed by the one or more processors cause the one or more processors to perform operations and functions associated with operation of a vehicle including receiving sensor data and/or vehicle data from a vehicle (e.g., the vehicle 108) or one or more remote computing devices, generating ride experience data based at least in part on the sensor data and/or the vehicle data, and/or determining a ride experience control signal associated with the operation of the vehicle.

For example, the operations computing system 104 can be configured to monitor and communicate with the vehicle 108 and/or its users to coordinate a vehicle service provided by the vehicle 108. To do so, the operations computing system 104 can manage a database that includes data including vehicle status data associated with the status of vehicles including the vehicle 108 The vehicle status data can include a location of a vehicle (e.g., a latitude and longitude of a vehicle), the availability of a vehicle (e.g., whether a vehicle is available to pick-up or drop-off passengers and/or cargo), or the state of objects external to a vehicle (e.g., the physical dimensions and/or appearance of objects external to the vehicle).

The operations computing system 104 can communicate with the one or more remote computing devices 106 and/or the vehicle 108 via one or more communications networks including the communications network 102. The communications network 102 can exchange (send or receive) signals (e.g., electronic signals) or data (e.g., data from a computing device) and include any combination of various wired (e.g., twisted pair cable) and/or wireless communication mechanisms (e.g., cellular, wireless, satellite, microwave, and radio frequency) and/or any desired network topology (or topologies). For example, the communications network 102 can include a local area network (e.g. intranet), wide area network (e.g. Internet), wireless LAN network (e.g., via Wi-Fi), cellular network, a SATCOM network, VHF network, a HF network, a WiMAX based network, and/or any other suitable communications network (or combination thereof) for transmitting data to and/or from the vehicle 108.

Each of the one or more remote computing devices 106 can include one or more processors and one or more memory devices. The one or more memory devices can be used to store instructions that when executed by the one or more processors of the one or more remote computing devise 106 cause the one or more processors to perform operations and/or functions including operations and/or functions associated with the vehicle 108 including exchanging (e.g., sending and/or receiving) data or signals with the vehicle 108, monitoring the state of the vehicle 108, and/or controlling the vehicle 108. The one or more remote computing devices 106 can communicate (e.g., exchange data and/or signals) with one or more devices including the operations computing system 104 and the vehicle 108 via the communications network 102. For example, the one or more remote computing devices 106 can request the location of the vehicle 108 via the communications network 102.

The one or more remote computing devices 106 can include one or more computing devices (e.g., a desktop computing device, a laptop computing device, a smart phone, and/or a tablet computing device) that can receive input or instructions from a user or exchange signals or data with an item or other computing device or computing system (e.g., the operations computing system 104). Further, the one or more remote computing devices 106 can be used to determine and/or modify one or more states of the vehicle 108 including a location (e.g., a latitude and longitude), a velocity, acceleration, a trajectory, and/or a path of the vehicle 108 based in part on signals or data exchanged with the vehicle 108. In some implementations, the operations computing system 104 can include the one or more remote computing devices 106.

The vehicle 108 can be a ground-based vehicle (e.g., an automobile), an aircraft, and/or another type of vehicle. The vehicle 108 can be an autonomous vehicle that can perform various actions including driving, navigating, and/or operating, with minimal and/or no interaction from a human driver. The autonomous vehicle 108 can be configured to operate in one or more modes including, for example, a fully autonomous operational mode, a semi-autonomous operational mode, a park mode, and/or a sleep mode. A fully autonomous (e.g., self-driving) operational mode can be one in which the vehicle 108 can provide driving and navigational operation with minimal and/or no interaction from a human driver present in the vehicle. A semi-autonomous operational mode can be one in which the vehicle 108 can operate with some interaction from a human driver present in the vehicle. Park and/or sleep modes can be used between operational modes while the vehicle 108 performs various actions including waiting to provide a subsequent vehicle service, and/or recharging between operational modes.

Furthermore, the vehicle 108 can include the one or more passenger compartment sensors, such as image sensors 109 and/or audio sensors 110, which can be positioned within a vehicle cabin and configured to obtain sensor data (e.g., image data and/or audio data) associated with one or more passengers of the vehicle. For example, one or more image sensors 109 (e.g., cameras and the like) can be positioned within a cabin of the vehicle 108 and configured to obtain image data descriptive of one or more passengers located within the cabin of the vehicle 108. Similarly, one or more audio sensors 110 (e.g., microphones and the like) can be positioned within the cabin of the vehicle 108 and configured to obtain audio data descriptive of one or more passengers located within the cabin of the vehicle 108. Image sensors 109 and/or audio sensors 110 can be provided in a variety of locations within the vehicle cabin, including but not limited to on the vehicle dash, in an overhead location within the cabin, and/or on interior doors or windows of a vehicle (e.g., vehicle 108), or other positions configured to obtain image data of passenger faces and bodies. It should be appreciated that vehicles, services, and/or applications that gather sensor data (e.g., image data obtained by image sensors 109 and/or audio data obtained by audio sensors 110) as described herein can be configured with options for permissions to be obtained from vehicle passengers before such sensor data is collected for authorized use in accordance with the disclosed techniques.

An indication, record, and/or other data indicative of the state of the vehicle, the state of one or more passengers of the vehicle, and/or the state of an environment including one or more objects (e.g., the physical dimensions and/or appearance of the one or more objects) can be stored locally in one or more memory devices of the vehicle 108. Additionally, the vehicle 108 can provide data indicative of the state of the vehicle, the state of one or more passengers of the vehicle, and/or the state of an environment to the operations computing system 104, which can store an indication, record, and/or other data indicative of the state of the one or more objects within a predefined distance of the vehicle 108 in one or more memory devices associated with the operations computing system 104 (e.g., remote from the vehicle). Furthermore, the vehicle 108 can provide data indicative of the state of the one or more objects (e.g., physical dimensions and/or appearance of the one or more objects) within a predefined distance of the vehicle 108 to the operations computing system 104, which can store an indication, record, and/or other data indicative of the state of the one or more objects within a predefined distance of the vehicle 108 in one or more memory devices associated with the operations computing system 104 (e.g., remote from the vehicle).

The vehicle 108 can include and/or be associated with the vehicle computing system 112. The vehicle computing system 112 can include one or more computing devices located onboard the vehicle 108. For example, the one or more computing devices of the vehicle computing system 112 can be located on and/or within the vehicle 108. The one or more computing devices of the vehicle computing system 112 can include various components for performing various operations and functions. For instance, the one or more computing devices of the vehicle computing system 112 can include one or more processors and one or more tangible, non-transitory, computer readable media (e.g., memory devices). The one or more tangible, non-transitory, computer readable media can store instructions that when executed by the one or more processors cause the vehicle 108 (e.g., its computing system, one or more processors, and other devices in the vehicle 108) to perform operations and functions, including those described herein for determining user device location data and controlling the vehicle 108 with regards to the same.

As depicted in FIG. 1, the vehicle computing system 112 can include the one or more autonomy system sensors 114; the positioning system 118; the autonomy computing system 120; the communication system 136; the vehicle control system 138; and the human-machine interface 140. One or more of these systems can be configured to communicate with one another via a communication channel. The communication channel can include one or more data buses (e.g., controller area network (CAN)), on-board diagnostics connector (e.g., OBD-II), and/or a combination of wired and/or wireless communication links. The onboard systems can exchange (e.g., send and/or receive) data, messages, and/or signals amongst one another via the communication channel.

The one or more autonomy system sensors 114 can be configured to generate and/or store data including the autonomy sensor data 116 associated with one or more objects that are proximate to the vehicle 108 (e.g., within range or a field of view of one or more of the one or more sensors 114). The one or more autonomy system sensors 114 can include a Light Detection and Ranging (LIDAR) system, a Radio Detection and Ranging (RADAR) system, one or more cameras (e.g., visible spectrum cameras and/or infrared cameras), motion sensors, and/or other types of imaging capture devices and/or sensors. The autonomy sensor data 116 can include image data, radar data, LIDAR data, and/or other data acquired by the one or more autonomy system sensors 114. The one or more objects can include, for example, pedestrians, vehicles, bicycles, and/or other objects. The one or more objects can be located on various parts of the vehicle 108 including a front side, rear side, left side, right side, top, or bottom of the vehicle 108. The autonomy sensor data 116 can be indicative of locations associated with the one or more objects within the surrounding environment of the vehicle 108 at one or more times. For example, autonomy sensor data 116 can be indicative of one or more LIDAR point clouds associated with the one or more objects within the surrounding environment. The one or more autonomy system sensors 114 can provide the autonomy sensor data 116 to the autonomy computing system 120.

In addition to the autonomy sensor data 116, the autonomy computing system 120 can retrieve or otherwise obtain data including the map data 122. The map data 122 can provide detailed information about the surrounding environment of the vehicle 108. For example, the map data 122 can provide information regarding: the identity and location of different roadways, road segments, buildings, or other items or objects (e.g., lampposts, crosswalks and/or curb); the location and directions of traffic lanes (e.g., the location and direction of a parking lane, a turning lane, a bicycle lane, or other lanes within a particular roadway or other travel way and/or one or more boundary markings associated therewith); traffic control data (e.g., the location and instructions of signage, traffic lights, or other traffic control devices); and/or any other map data that provides information that assists the vehicle computing system 112 in processing, analyzing, and perceiving its surrounding environment and its relationship thereto.

The vehicle computing system 112 can include a positioning system 118. The positioning system 118 can determine a current position of the vehicle 108. The positioning system 118 can be any device or circuitry for analyzing the position of the vehicle 108. For example, the positioning system 118 can determine position by using one or more of inertial sensors, a satellite positioning system, based on IP/MAC address, by using triangulation and/or proximity to network access points or other network components (e.g., cellular towers and/or Wi-Fi access points) and/or other suitable techniques. The position of the vehicle 108 can be used by various systems of the vehicle computing system 112 and/or provided to one or more remote computing devices (e.g., the operations computing system 104 and/or the remote computing device 106). For example, the map data 122 can provide the vehicle 108 relative positions of the surrounding environment of the vehicle 108. The vehicle 108 can identify its position within the surrounding environment (e.g., across six axes) based at least in part on the data described herein. For example, the vehicle 108 can process the autonomy sensor data 116 (e.g., LIDAR data, camera data) to match it to a map of the surrounding environment to get an understanding of the vehicle's position within that environment (e.g., transpose the vehicle's position within its surrounding environment).

The autonomy computing system 120 can include a perception system 124, a prediction system 126, a motion planning system 128, and/or other systems that cooperate to perceive the surrounding environment of the vehicle 108 and determine a motion plan for controlling the motion of the vehicle 108 accordingly. For example, the autonomy computing system 120 can receive the autonomy sensor data 116 from the one or more autonomy system sensors 114, attempt to determine the state of the surrounding environment by performing various processing techniques on the autonomy sensor data 116 (and/or other data), and generate an appropriate motion plan through the surrounding environment. The autonomy computing system 120 can control the one or more vehicle control systems 138 to operate the vehicle 108 according to the motion plan.

The perception system 124 can identify one or more objects that are proximate to the vehicle 108 based on autonomy sensor data 116 received from the autonomy system sensors 114. In particular, in some implementations, the perception system 124 can determine, for each object, state data 130 that describes a current state of such object. As examples, the state data 130 for each object can describe an estimate of the object's: current location (also referred to as position); current speed; current heading (which may also be referred to together as velocity); current acceleration; current orientation; size/footprint (e.g., as represented by a bounding shape such as a bounding polygon or polyhedron); class of characterization (e.g., vehicle class versus pedestrian class versus bicycle class versus other class); yaw rate; and/or other state information. In some implementations, the perception system 124 can determine state data 130 for each object over a number of iterations. In particular, the perception system 124 can update the state data 130 for each object at each iteration. Thus, the perception system 124 can detect and track objects (e.g., vehicles, bicycles, pedestrians, etc.) that are proximate to the vehicle 108 over time, and thereby produce a presentation of the world around an vehicle 108 along with its state (e.g., a presentation of the objects of interest within a scene at the current time along with the states of the objects).

The prediction system 126 can receive the state data 130 from the perception system 124 and predict one or more future locations and/or moving paths for each object based on such state data. For example, the prediction system 126 can generate prediction data 132 associated with each of the respective one or more objects proximate to the vehicle 108. The prediction data 132 can be indicative of one or more predicted future locations of each respective object. The prediction data 132 can be indicative of a predicted path (e.g., predicted trajectory) of at least one object within the surrounding environment of the vehicle 108. For example, the predicted path (e.g., trajectory) can indicate a path along which the respective object is predicted to travel over time (and/or the velocity at which the object is predicted to travel along the predicted path). The prediction system 126 can provide the prediction data 132 associated with the one or more objects to the motion planning system 128.

The motion planning system 128 can determine a motion plan and generate motion plan data 134 for the vehicle 108 based at least in part on the prediction data 132 (and/or other data). The motion plan data 134 can include vehicle actions with respect to the objects proximate to the vehicle 108 as well as the predicted movements. For instance, the motion planning system 128 can implement an optimization algorithm that considers cost data associated with a vehicle action as well as other objective functions (e.g., cost functions based on speed limits, traffic lights, and/or other aspects of the environment), if any, to determine optimized variables that make up the motion plan data 134. By way of example, the motion planning system 128 can determine that the vehicle 108 can perform a certain action (e.g., pass an object) without increasing the potential risk to the vehicle 108 and/or violating any traffic laws (e.g., speed limits, lane boundaries, signage). The motion plan data 134 can include a planned trajectory, velocity, acceleration, and/or other actions of the vehicle 108.

As one example, in some implementations, the motion planning system can determine a cost function for each of one or more candidate motion plans for the autonomous vehicle based at least in part on the current locations and/or predicted future locations and/or moving paths of the objects. For example, the cost function can describe a cost (e.g., over time) of adhering to a particular candidate motion plan. For example, the cost described by a cost function can increase when the autonomous vehicle approaches impact with another object and/or deviates from a preferred pathway (e.g., a predetermined travel route).

Thus, given information about the current locations and/or predicted future locations and/or moving paths of objects, the motion planning system can determine a cost of adhering to a particular candidate pathway. The motion planning system can select or determine a motion plan for the autonomous vehicle based at least in part on the cost function(s). For example, the motion plan that minimizes the cost function can be selected or otherwise determined. The motion planning system then can provide the selected motion plan to a vehicle controller that controls one or more vehicle controls (e.g., actuators or other devices that control gas flow, steering, braking, etc.) to execute the selected motion plan.

The motion planning system 128 can provide the motion plan data 134 with data indicative of the vehicle actions, a planned trajectory, and/or other operating parameters to the vehicle control systems 138 to implement the motion plan data 134 for the vehicle 108. For instance, the vehicle 108 can include a mobility controller configured to translate the motion plan data 134 into instructions. By way of example, the mobility controller can translate a determined motion plan data 134 into instructions for controlling the vehicle 108 including adjusting the steering of the vehicle 108 “X” degrees and/or applying a certain magnitude of braking force. The mobility controller can send one or more control signals to the responsible vehicle control component (e.g., braking control system, steering control system and/or acceleration control system) to execute the instructions and implement the motion plan data 134.

The vehicle computing system 112 can include a communications system 136 configured to allow the vehicle computing system 112 (and its one or more computing devices) to communicate with other computing devices. The vehicle computing system 112 can use the communications system 136 to communicate with the operations computing system 106 and/or one or more other remote computing devices (e.g., the one or more remote computing devices 106) over one or more networks (e.g., via one or more wireless signal connections). In some implementations, the communications system 136 can allow communication among one or more of the system on-board the vehicle 108. The communications system 136 can also be configured to enable the autonomous vehicle to communicate with and/or provide and/or receive data and/or signals from a remote computing device 106 associated with a user and/or an item (e.g., an item to be picked-up for a courier service). The communications system 136 can utilize various communication technologies including, for example, radio frequency signaling and/or Bluetooth low energy protocol. The communications system 136 can include any suitable components for interfacing with one or more networks, including, for example, one or more: transmitters, receivers, ports, controllers, antennas, and/or other suitable components that can help facilitate communication. In some implementations, the communications system 136 can include a plurality of components (e.g., antennas, transmitters, and/or receivers) that allow it to implement and utilize multiple-input, multiple-output (MIMO) technology and communication techniques.

The vehicle computing system 112 can include the one or more human-machine interfaces 140. For example, the vehicle computing system 112 can include one or more display devices located on the vehicle computing system 112. A display device (e.g., screen of a tablet, laptop, and/or smartphone) can be viewable by a user of the vehicle 108 that is located in the front of the vehicle 108 (e.g., driver's seat, front passenger seat). Additionally, or alternatively, a display device can be viewable by a user of the vehicle 108 that is located in the rear of the vehicle 108 (e.g., a back passenger seat).

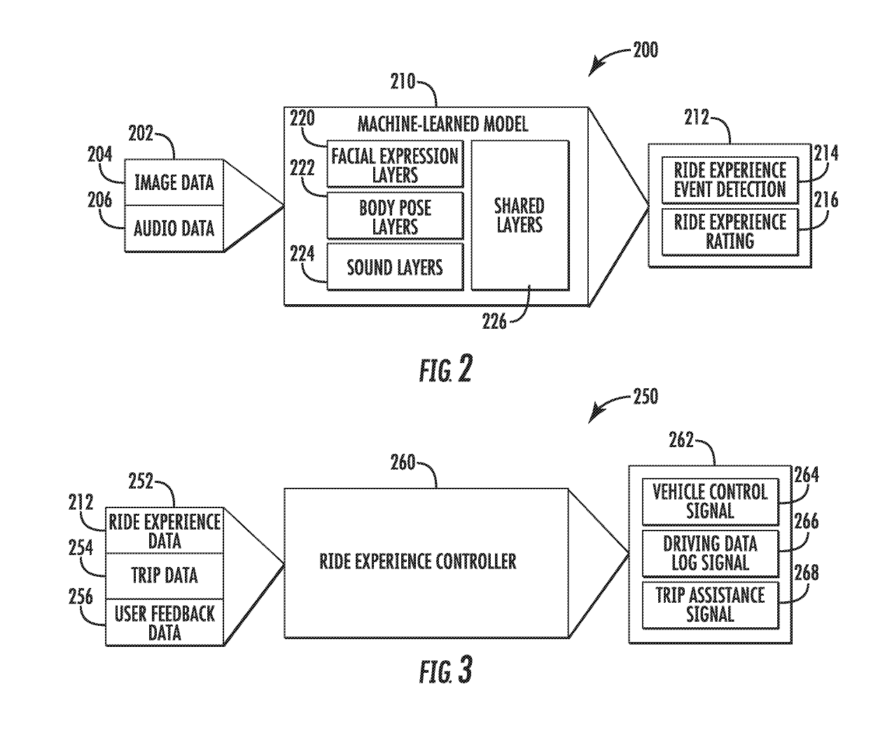

FIG. 2 depicts a block diagram 200 of an example machine-learned ride experience model according to example embodiments of the present disclosure. In some implementations, as illustrated in FIG. 2, a machine-learned ride experience model 210 can receive sensor data 202 as input to the model. The machine learned ride experience model 210 can then generate ride experience data 212 as output of the model.

As illustrated in FIG. 2, sensor data 202 associated with one or more passengers of a vehicle (e.g., an vehicle 108 as depicted in FIG. 1, etc.) can be obtained from one or more sensors positioned within a cabin of the vehicle (e.g., image sensors 109 and/or audio sensors 110 of FIG. 1). The sensor data 202 can comprise image data 204 (e.g., from one or more cameras, etc.) and/or audio data 206 (e.g., from one or more microphones, etc.). The image sensors and/or audio sensors can be provided in a variety of locations within a vehicle cabin, including but not limited to on the vehicle dash, in an overhead location within the cabin, and/or on interior doors or windows of a vehicle, or other positions configured to obtain image data of passenger faces and bodies.

The sensor data 202 can be provided as input to a machine-learned ride experience model 210 that is trained to determine ride experience data in response to receiving the sensor data 202 as input. In some implementations, the machine-learned ride experience model 210 can include one or more layers configured to implement one or more types of analysis which can be used to determine ride experience data. For example, the machine-learned ride experience model 210 include one or more facial expression layers 220, body pose layers 222, sound layers 224, and or shared layers 226 that can provide for one or more of facial expression analysis, body pose analysis, and sound analysis based in part on the sensor data 202.

For example, when the machine-learned ride experience model 210 is configured to implement facial expression analysis, image data 204 can be analyzed by one or more facial expression layers 220 within the machine-learned ride experience model 210. The machine-learned ride experience model 210 can be trained to analyze the entire canvas of each passenger's face as detected within image data 204 from the one or more passenger sensors and to correlate the facial expression of each passenger with a predetermined type of ride experience event and/or rating.

In another example, when the machine-learned ride experience model 210 is configured to implement body pose analysis, image data 204 can be analyzed by one or more body pose layers 222 within the machine-learned ride experience model 210. The machine-learned ride experience model 210 can be trained to analyze at least a portion of each passenger's body as detected within image data 204 from the one or more passenger sensors and to correlate body pose of each passenger with a predetermined type of ride experience event and/or rating.

In another example, when the machine-learned ride experience model 210 is configured to implement sound analysis, audio data 206 can be analyzed according to one or more sound layers 224 within the machine-learned ride experience model 210. The machine-learned ride experience model 210 can be trained to analyze at least a portion of each passenger's sound (e.g., words, noises, absence of sound, or other passenger utterances) as detected within audio data 206 from the one or more passenger sensors and to correlate sound from each passenger with a predetermined type of ride experience event and/or rating.

In some implementations, the machine-learned ride experience model 210 can also include one or more shared layers 226. The one or more shared layers 226 can combine analysis from the different first layers (e.g., facial expression layers 220, body pose layers 222, sound layers 224, etc.) to determine how the different types of analysis (e.g., facial expression analysis, body pose analysis, sound analysis, etc.) combine in determining ride experience data that characterizes the overall ride experience of one or more passengers. In some implementations, the first layers (e.g., facial expression layers 220, body pose layers 222, sound layers 224, etc.) can also include some shared layers (e.g., those layers dedicated to analyzing image data that apply to both facial expression analysis and body pose analysis).

By providing a machine-learned model that has been trained to analyze multiple joint variables, improved determination of some variables (e.g., facial expressions, body poses, sounds, etc.) can lead to improved determination of ride experience data as a whole. For example, improved determination of facial expressions can help improve a detected class of passenger experience event type. By co-training a machine-learned model across multiple desired factors (e.g., multiple types of sensor data analysis), an efficient model can be utilized. In addition, by providing ride experience control that is dependent on multiple parameters, the disclosed technology can provide more comprehensive analysis and improvement of the ride experience.

The machine-learned ride experience model 210 can be configured to output a single type or multiple types of ride experience data 212. For example, ride experience data 212 can include ride experience event detection data 214 (e.g., ride experience events detected from the sensor data 202) and ride experience rating data 216 (e.g., a classification for each detected ride experience event according to a ride experience rating). In some implementations, ride experience events (e.g., ride experience event detection data 214) can be selected from a predetermined class of ride experience event types (e.g., a good passenger experience event, a bad passenger experience event). In other implementations, ride experience ratings (e.g., ride experience rating data 216) can be dynamically determined within a range of values (e.g., a score determined within a range from 0 to 10, with 0 corresponding to a least favorable level of passenger experience and 10 corresponding to a most favorable level of passenger experience).

The resultant ride experience data 212 output by the machine-learned ride experience model 210, including ride experience event detection data 214 and/or associated ride experience rating data 216, can thus provide real-time and/or historical information that can be used to improve the passenger ride experience.

FIG. 3 depicts a block diagram of an example ride experience control system 250 according to example embodiments of the present disclosure. In some implementations, a ride experience controller 260 can be provided which can receive various input data 252 and provide one or more ride experience control signals 262 associated with operation of the vehicle. For example, a ride experience controller 260 can obtain one or more of ride experience data 212, trip data 254, and/or user feedback data 256 for use in determining one or more ride experience control signals 262, such as vehicle control signal 264, driving data log signal 266, and/or trip assistance signal 268.

As an example, ride experience data 212 generated by the disclosed machine-learned ride experience model 210 can be provided alone or in combination with other types of data to a ride experience controller 260. In some implementations, additional data provided to the ride experience controller can include trip data 254 that identifies one or more states of the vehicle in which the passengers are traveling. For instance, trip data 254 can include one or more positions of the vehicle, locations of the vehicle, velocities of the vehicle, accelerations of the vehicle, events associated with movement of the vehicle (e.g., predetermined types of events such as jerks, jukes, kickouts, etc.) In some implementations, additional data provided to the ride experience controller can include user feedback data 256, for example, data provided directly by the one or more passengers indicating their feedback regarding the ride experience (e.g., a good ride experience, a ride experience rated 7.5 on a scale of 1-10, a desire to stop the ride, etc.).

When multiple portions of input data 252 are received, the ride experience controller 260 can correlate such data across time and/or trip distance so that the ride experience data 212, trip data 254, and/or user feedback data 256 associated with a single moment can all be analyzed collectively. As such, if ride experience data 212 indicates a bad experience based on passenger facial expressions (e.g., grimacing face) at time t, and trip data 254 indicates a sharp braking at the same time t (or within a threshold time difference from time t), then the ride experience controller 260 may be able to identify and leverage when different portions of data 252 all point to a similar type of passenger experience.

Based on correlation and analysis by the ride experience controller 260, the ride experience controller 260 can determine one or more ride experience control signals 262 associated with operation of the vehicle as output. In some implementations, a ride experience control signal 262 can include one or more of a vehicle control signal 264, a driving data log signal 266, and/or a trip assistance signal 268.

A vehicle control signal 264 can include a signal that is directed to a vehicle controller (e.g., via vehicle control system 138 of FIG. 1, etc.) that controls one or more vehicle controls (e.g., actuators or other devices that control gas flow, steering, braking, etc.). In some implementations (e.g., those involving autonomous vehicles), the vehicle control signal 264 can be provided to or through a vehicle autonomy system (e.g., autonomy computing system 120 of FIG. 1, etc.) that is configured to generate a motion plan for autonomously navigating the vehicle through its environment. In such instances, the vehicle control signal 264 can adjust the motion plan according to ride experience data to speed up, slow down, stop, etc. as appropriate.

In some implementations, a driving data log signal 266 can include a control signal that triggers storage of data associated with a detected ride experience event. For example, if passenger sensor data is obtained and stored only temporarily in a memory buffer, then a driving data log signal 266 can be generated that controls the memory buffer to transfer sensor data and/or ride experience data associated with detected ride experience events to a permanent memory for subsequent analysis. In some implementations, the driving data log signal 266 can include a control signal that triggers updating of a ride experience event counter and/or related information. Updating of a ride experience event counter can help determine other metrics associated with overall passenger ride experience such as a total number of good and/or bad experiences, number of miles since last bad experience, or other parameters that can be indicative of the overall ride experience for a passenger, trip, or vehicle.

In some implementations, a trip assistance signal 268 can include a control signal that is transmitted to a location remote from the vehicle. The trip assistance signal 268 can include a request to initiate two-way conversation with the vehicle (e.g., with passengers located within the cabin of the vehicle) to facilitate further communication and determination of subsequent assistance steps. Subsequent assistance steps can include, for example, slowing of the vehicle, stopping of the vehicle, rerouting of the vehicle, transmission of third party aid to the current location or predicted future location of the vehicle, etc.

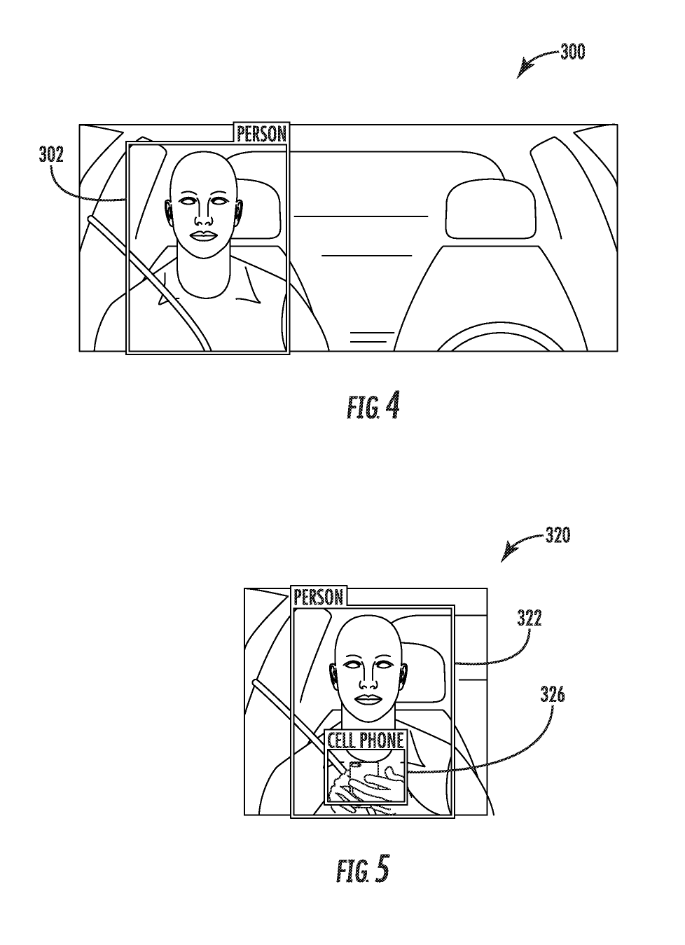

FIGS. 4 and 5 depict example portions of image data and objects of interest determined by a ride experience model according to example embodiments of the present disclosure. As described herein, one or more image sensors (e.g., image sensors 109 of FIG. 1) positioned within the cabin of a vehicle can capture image data, such as image data 300 in FIG. 4 and image data 320 in FIG. 5. Image data 300/320 can be provided as input to a machine-learned ride experience model (e.g., machine-learned ride experience model 210 of FIG. 2). In some implementations, as part of analyzing facial expression and/or body pose, the machine-learned ride experience model can be configured to detect one or more objects of interest within a vehicle cabin. Objects of interest can include, but are not limited to passengers (e.g., people, pets, etc.), phones, weapons, etc. For example, as illustrated in FIG. 4, a machine-learned ride experience model may analyze image data 300 and detect a person 302 in the image data 300. In another example, as illustrated in FIG. 5, a machine-learned ride experience model may analyze image data 320 and detect both a person 322 and a cell phone 326 in the image data 320.

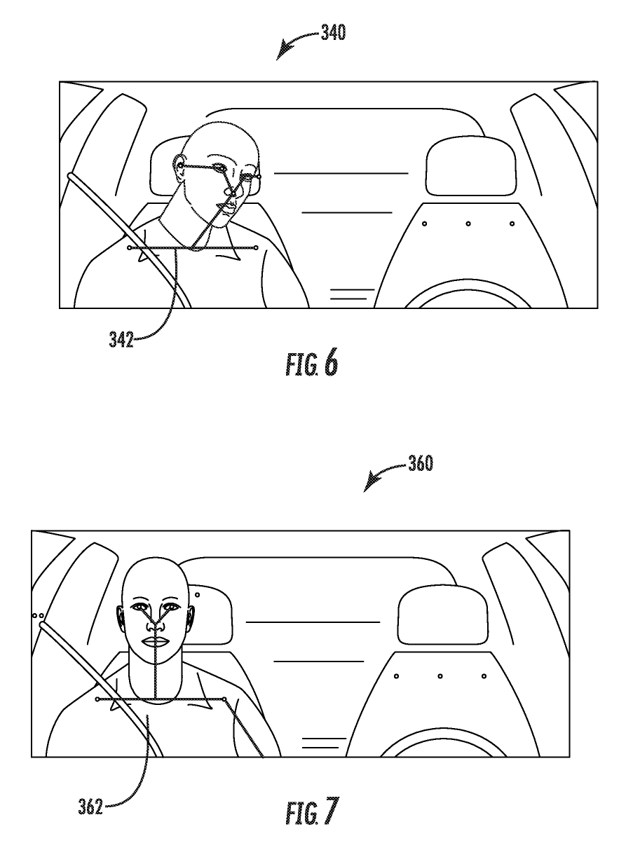

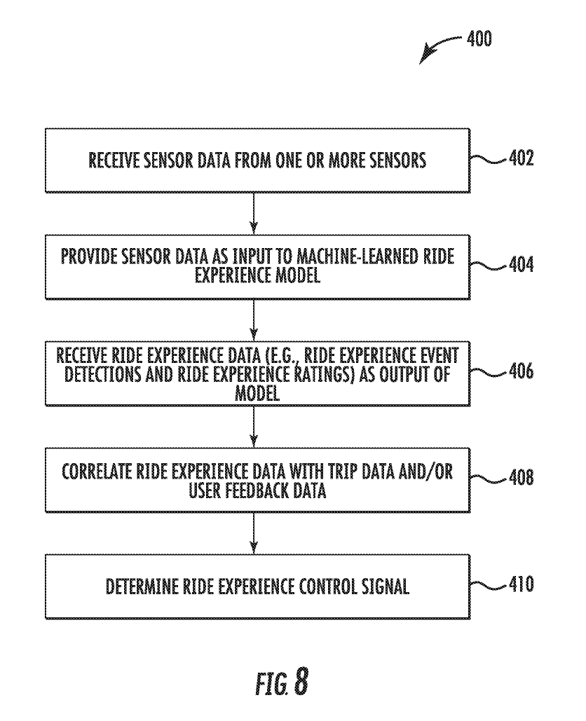

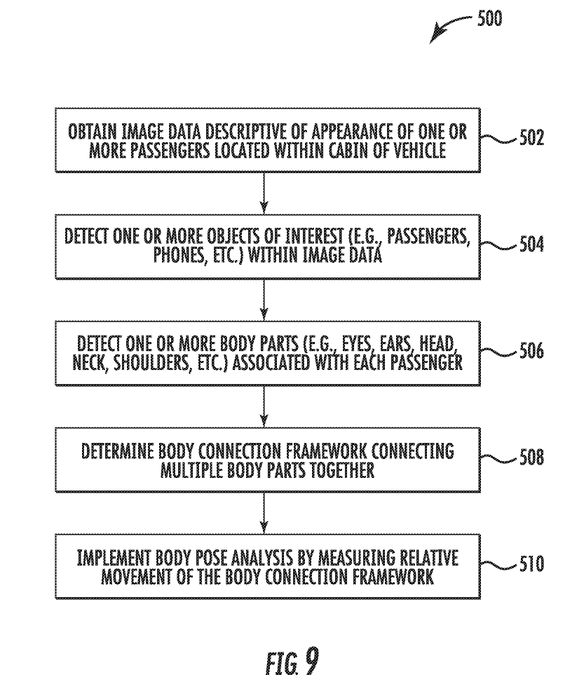

FIGS. 6 and 7 depict example portions of image data and body connection frameworks determined by a ride experience model according to example embodiments of the present disclosure. As described herein, one or more image sensors (e.g., image sensors 109 of FIG. 1) positioned within the cabin of a vehicle can capture image data, such as image data 340 in FIG. 6 and image data 360 in FIG. 7, which can be provided as input to a machine-learned ride experience model. For each passenger detected within the image data (e.g., image data 340/360), the machine-learned ride experience model can further detect one or more body parts associated with the one or more passengers located within the cabin of the vehicle. For body pose analysis, the body parts can include head, shoulders, neck, eyes, and the like. In some implementations, the machine-learned ride experience model can be configured to determine a body connection framework (e.g., an assembly of one or more line segments connecting selected body parts together), such as body connection framework 342 in FIG. 6 and body connection framework 362 in FIG. 7, connecting multiple of the one or more body parts together. For example, body connection frameworks 342 and 362 connect visible portions of a passenger's ears, eyes, neck, shoulders, and arms/hands. Body pose analysis can be implemented by measuring relative movement of the body connection framework from one time frame to the next. As an example, the machine-learned ride experience model can be configured to determine a body connection framework 342 in FIG. 6 and a body connection framework 362 in FIG. 7 and determine the relative movement of the body connection framework 342/362 as part of the body pose analysis.

FIG. 8 depicts a flowchart diagram of an example method 400 of determining passenger ride experience according to example embodiments of the present disclosure. As described herein, in some implementations, a machine-learned ride experience model can be trained to receive the sensor data as input, and in response to receipt of the sensor data, generate ride experience data as output. One or more portion(s) of the method 400 can be implemented by one or more computing devices such as, for example, the operations computing system 104 of FIG. 1, the vehicle computing system 112 of FIG. 1, the computing system 710 of FIG. 11, the machine learning computing system 750 of FIG. 11, and/or the like. Each respective portion of the method 400 can be performed by any (or any combination) of the one or more computing devices. Moreover, one or more portion(s) of the method 400 can be implemented as an algorithm on the hardware components of the device(s) described herein (e.g., as in FIGS. 1 and 11), for example, to provide for generating ride experience data as described herein. FIG. 8 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure.

At 402, the method 400 can include one or more computing devices included within a computing system (e.g., computing system 104, 112, 710, 750, and/or the like) receiving sensor data from one or more sensors positioned within a vehicle. For example, a passenger cabin of a vehicle can include one or more passenger sensors that are configured to obtain sensor data associated with the one or more passengers. As an example, one or more image sensors (e.g., cameras and the like) can be positioned within a cabin of a vehicle and configured to obtain image data descriptive of one or more passengers located within the cabin of the vehicle. Similarly, one or more audio sensors (e.g., microphones and the like) can be positioned within the cabin of the vehicle and configured to obtain audio data descriptive of one or more passengers located within the cabin of the vehicle. Image sensors and/or audio sensors can be provided in a variety of locations within the vehicle cabin, including but not limited to on the vehicle dash, in an overhead location within the cabin, and/or on interior doors or windows of a vehicle, or other positions configured to obtain image data of passenger faces and bodies.

At 404, the computing system can provide the sensor data as input to a machine-learned ride experience model that is trained to determine ride experience data in response to receiving the sensor data as input. In some implementations, the machine-learned ride experience model can be configured to implement one or more of facial expression analysis, body pose analysis, and sound analysis. A combination of one or more types of analysis can be used by the machine-learned ride experience model to determine ride experience data that is based in part on the facial expression analysis, body pose analysis, and/or sound analysis.

At 406, the computing system can receive ride experience data as output of the machine-learned ride experience model. Ride experience data can include, for example, ride experience event detections and/or ride experience ratings associated with the event detections. For example, a ride experience rating can classify each detected ride experience event by selecting from a predetermined class of events (e.g., a good passenger experience event and a bad passenger experience event). Additionally or alternatively, a ride experience rating can classify each detected ride experience event by dynamically determining the ride experience rating on a gradient scale within a range of possible values (e.g., a scale from 0-10).

When the machine-learned ride experience model is configured to implement facial expression analysis, image data can be analyzed by one or more facial expression layers within the machine-learned ride experience model. The machine-learned ride experience model can be trained to analyze the entire canvas of each passenger's face as detected within image data from the one or more passenger sensors and to correlate the facial expression of each passenger with a predetermined type of ride experience event and/or rating. For example, instead of using hand-crafted rules or detailed algorithms for analyzing different facial expressions and/or micro-expressions, training data can configure the machine-learned ride experience model to identify when certain facial expressions correspond to a “good” ride experience event, a “bad” ride experience event, and/or a gradient rating associated with the overall ride experience at the time the sensor data was obtained.

At 408, the computing system can correlate the ride experience data with trip data and/or user feedback data. For example, in addition to the ride experience data provided by the machine-learned ride experience model, the computing system can obtain additional data such as trip data (e.g., data that identifies one or more states of the vehicle in which the passengers are traveling, etc.) and/or user feedback data (e.g., data provided directly by the one or more passengers indicating their feedback regarding the ride experience, etc.). The computing system can correlate such data across time and/or trip distance so that the ride experience data, trip data, and/or user feedback data associated with a single moment can all be analyzed collectively. As such, if ride experience data indicates a bad experience based on passenger facial expressions (e.g., grimacing face) at time t, and trip data indicates a sharp braking at the same time t (or within a threshold time difference from time t), then the ride experience controller is able to identify and leverage when different portions of data all point to a similar type of passenger experience.

At 410, the computing system can determine a ride experience control signal. For example, based on the correlation and analysis of the ride experience data, trip data, and/or user feedback data, the ride experience controller can determine one or more ride experience control signals associated with operation of the vehicle as output. In some implementations, a ride experience control signal can include one or more of a vehicle control signal, a driving data log signal, and/or a trip assistance signal.

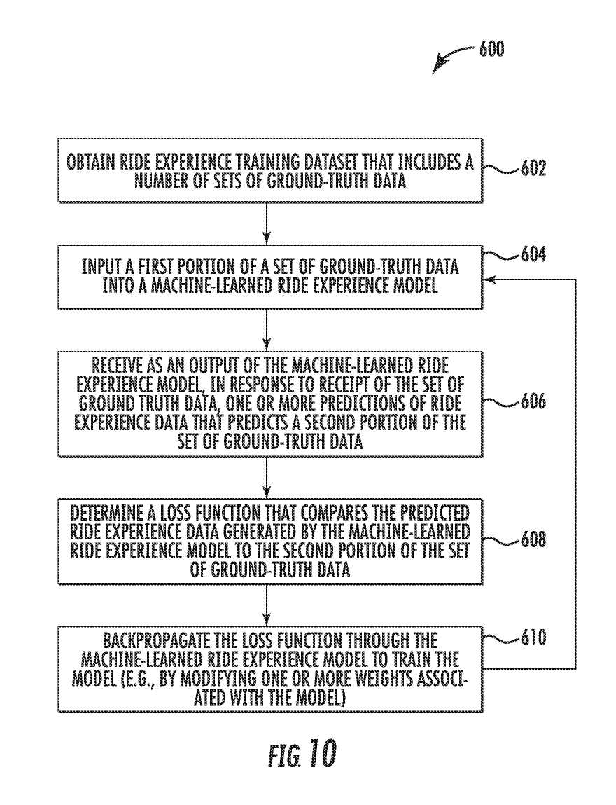

FIG. 9 depicts a flowchart diagram of an example method 500 of analyzing body pose as part of determining passenger ride experience according to example embodiments of the present disclosure. Although method 500 describes body pose analysis, similar techniques can be applied for facial expression analysis. One or more portion(s) of the method 500 can be implemented by one or more computing devices such as, for example, the operations computing system 104 of FIG. 1, the vehicle computing system 112 of FIG. 1, the computing system 710 of FIG. 11, the machine learning computing system 750 of FIG. 11, and/or the like. Each respective portion of the method 500 can be performed by any (or any combination) of the one or more computing devices. Moreover, one or more portion(s) of the method 500 can be implemented as an algorithm on the hardware components of the device(s) described herein (e.g., as in FIGS. 1 and 11), for example, to provide for generating ride experience data as described herein. FIG. 9 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure.

At 502, the method 500 can include one or more computing devices included within a computing system (e.g., computing system 104, 112, 710, 750, and/or the like) obtaining image data descriptive of an appearance of one or more passengers located within a cabin of a vehicle. For example, a passenger cabin of a vehicle can include one or more image sensors (e.g., cameras and the like) that are configured to obtain image data descriptive of one or more passengers located within the cabin of the vehicle. Image sensors can be provided in a variety of locations within the vehicle cabin, including but not limited to on the vehicle dash, in an overhead location within the cabin, and/or on interior doors or windows of a vehicle, or other positions configured to obtain image data of passenger faces and bodies.

At 504, the computing system can detect one or more objects of interest (e.g., passengers, phones, etc.) within the image data. For example, a machine-learned ride experience model can be configured to detect one or more objects of interest within a vehicle cabin based on the image data. Objects of interest can include, but are not limited to passengers, phones, weapons, etc.

At 506, the computing system can detect one or more body parts (e.g., eyes, ears, head, neck, shoulders, arms, etc.) associated with each detected passenger. For example, a machine-learned ride experience model can detect one or more body parts associated with the one or more passengers located within the cabin of the vehicle based on the image data.

At 508, the computing system can determine a body connection framework connecting together multiple body parts of a detected passenger. The body connection framework can comprise an assembly of one or more line segments connecting selected body parts together.

At 510, the computing system can implement body pose analysis by measuring relative movement of the body connection framework from one time frame to the next.

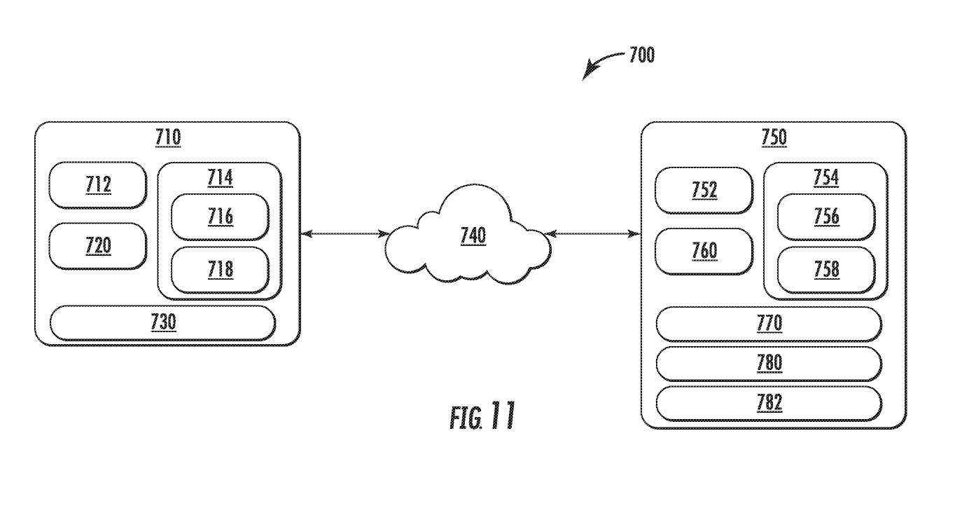

FIG. 10 depicts a flowchart diagram of an example method 600 of training a machine-learned ride experience model according to example embodiments of the present disclosure. As described herein, in some implementations, a machine-learned ride experience model can be trained to receive the sensor data as input, and in response to receipt of the sensor data, generate ride experience data as output. One or more portion(s) of the method 600 can be implemented by one or more computing devices such as, for example, the operations computing system 104 of FIG. 1, the vehicle computing system 112 of FIG. 1, the computing system 710 of FIG. 11, the machine learning computing system 750 of FIG. 11, and/or the like. Each respective portion of the method 600 can be performed by any (or any combination) of the one or more computing devices. Moreover, one or more portion(s) of the method 600 can be implemented as an algorithm on the hardware components of the device(s) described herein (e.g., as in FIGS. 1 and 11), for example, to provide for generating ride experience data as described herein. FIG. 10 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure.

At 602, the method 600 can include one or more computing devices included within a computing system (e.g., computing system 104, 112, 710, 750, and/or the like) obtaining a ride experience training dataset that includes a number of sets of ground-truth data. For example, to train a machine-learned ride experience model to analyze image data and/or audio data associated with vehicle passengers and generate ride experience data, a ride experience training dataset can be obtained that includes a large number of previously obtained representations of sensor data and corresponding labels that describe corresponding ride experience data (e.g., particular ride experience events and/or ride experience ratings) associated with the corresponding sensor data.

The ride experience training dataset can include a first portion of data corresponding to one or more representations of sensor data (e.g., image data and/or audio data) originating from sensors within the cabin of a vehicle. The sensor data can, for example, be recorded while a vehicle is in navigational operation. The ride experience training dataset can further include a second portion of data corresponding to labels identifying ride experience events and/or ratings associated with detected events. The labels included within the second portion of data within the training dataset can be manually annotated, automatically annotated, or annotated using a combination of automatic labeling and manual labeling.

At 604, the computing system can input a first portion of a set of ground-truth data into a machine-learned ride experience model. For example, to train the ride experience model, a training computing system can input a first portion of a set of ground-truth data (e.g., the first portion of the training dataset corresponding to the one or more representations of sensor data) into the machine-learned ride experience model to be trained. As an example, the set of training data can include a variety of facial expression samples that encompass a wide range of facial features including different eye positions, eyebrow positions, mouth positions, face wrinkling, and/or other facial gestures that would correspond to the different passenger experience event types and/or ratings. In another example, the set of training data can include a variety of body pose samples that encompass a wide range of poses including comfortable poses, uncomfortable poses, and/or other body poses and/or gestures that would correspond to the different passenger experience event types and/or ratings. In a further example, the set of training data can include a variety of sound samples that encompass a wide range of sounds including most favorable sounds and/or least favorable sounds and those in between that would correspond to the different passenger experience event types and/or ratings.

At 606, the computing system can receive as output of the machine-learned ride experience model, in response to receipt of the ground-truth data, one or more predictions of ride experience data that predicts a second portion of the set of ground-truth data. For example, in response to receipt of a first portion of a set of ground-truth data, the machine-learned ride experience model can output detected ride experience events and associated ride experience ratings. This output of the machine-learned ride experience model predicts the remainder of the set of ground-truth data (e.g., the second portion of the training dataset).

At 608, the computing system can determine a loss function that compares the predicted ride experience data generated by the machine-learned ride experience model to the second portion of the set of ground-truth data. For example, after receiving such predictions, a training computing system can apply or otherwise determine a loss function that compares the ride experience event detections and associated ratings output by the machine-learned ride experience model to the remainder of the ground-truth data (e.g., ground-truth labels) which the ride experience model attempted to predict.

At 610, the computing system can backpropogate the loss function through the machine-learned ride experience model to train the model (e.g., by modifying one or more weights associated with the model). This process of inputting ground-truth data, determining a loss function, and backpropagating the loss function through the ride experience model can be repeated numerous times as part of training the ride experience model. For example, the process can be repeated for each of numerous sets of ground-truth data provided within the ride experience training dataset.

FIG. 11 depicts a block diagram of an example computing system 700 according to example embodiments of the present disclosure. The example computing system 700 includes a computing system 710 and a machine learning computing system 750 that are communicatively coupled over a network 740.

In some implementations, the computing system 710 can perform various operations including the determination of one or more states of a vehicle (e.g., the vehicle 108) including the vehicle's location, position, orientation, velocity, and/or acceleration; the determination of one or more states of one or more objects inside the vehicle (e.g., one or more passengers of the vehicle); the determination of one or more ride experience events and/or ratings associated with a vehicle ride; and/or the determination of the state of the environment proximate to the vehicle including the state of one or more objects proximate to the vehicle (e.g., the object's physical dimensions, location, position, orientation, velocity, acceleration, shape, and/or color). In some implementations, the computing system 710 can be included in an autonomous vehicle. For example, the computing system 710 can be on-board the autonomous vehicle. In other implementations, the computing system 710 is not located on-board the autonomous vehicle. For example, the computing system 710 can operate offline to determine one or more states of a vehicle (e.g., the vehicle 108) including the vehicle's location, position, orientation, velocity, and/or acceleration; determine one or more states of one or more objects inside the vehicle (e.g., one or more passengers inside the vehicle); and/or determine the state of the environment proximate to the vehicle including the state of one or more objects proximate to the vehicle (e.g., the object's physical dimensions, location, position, orientation, velocity, acceleration, shape, and/or color). Further, the computing system 710 can include one or more distinct physical computing devices.

The computing system 710 includes one or more processors 712 and a memory 714. The one or more processors 712 can be any suitable processing device (e.g., a processor core, a microprocessor, an ASIC, a FPGA, a controller, and/or a microcontroller) and can be one processor or a plurality of processors that are operatively connected. The memory 714 can include one or more non-transitory computer-readable storage media, including RAM, ROM, EEPROM, EPROM, one or more memory devices, flash memory devices, and/or combinations thereof.

The memory 714 can store information that can be accessed by the one or more processors 712. For instance, the memory 714 (e.g., one or more non-transitory computer-readable storage mediums, memory devices) can store data 716 that can be obtained, received, accessed, written, manipulated, created, and/or stored. The data 716 can include, for instance, data associated with the determination of the state of a vehicle and one or more passengers of the vehicle as described herein. In some implementations, the computing system 710 can obtain data from one or more memory devices that are remote from the system 710.

The memory 714 can also store computer-readable instructions 718 that can be executed by the one or more processors 712. The instructions 718 can be software written in any suitable programming language or can be implemented in hardware. Additionally, or alternatively, the instructions 718 can be executed in logically and/or virtually separate threads on the one or more processors 712.

For example, the memory 714 can store instructions 718 that when executed by the one or more processors 712 cause the one or more processors 712 to perform any of the operations and/or functions described herein, including, for example, determining the state of a vehicle (e.g., the vehicle 108) and/or determining ride experience events and/or ride experience ratings.

According to an aspect of the present disclosure, the computing system 710 can store or include one or more machine-learned models 730. As examples, the machine-learned models 730 can be or can otherwise include various machine-learned models including, for example, neural networks (e.g., deep neural networks), support vector machines, decision trees, ensemble models, k-nearest neighbors models, Bayesian networks, or other types of models including linear models and/or non-linear models. Example neural networks include feed-forward neural networks, recurrent neural networks (e.g., long short-term memory recurrent neural networks), convolutional neural networks, or other forms of neural networks. In some implementations, machine-learned models 730 can include a machine-learned ride experience model (e.g., machine-learned ride experience model 210 of FIG. 2).

In some implementations, the computing system 710 can receive the one or more machine-learned models 730 from the machine learning computing system 750 over the network 740 and can store the one or more machine-learned models 730 in the memory 714. The computing system 710 can then use or otherwise implement the one or more machine-learned models 730 (e.g., by the one or more processors 712). In particular, the computing system 710 can implement the one or more machine-learned models 730 to determine ride experience data such as ride experience event detections and/or ride experience ratings associated with the event detections.

The machine learning computing system 750 includes one or more processors 752 and a memory 754. The one or more processors 752 can be any suitable processing device (e.g., a processor core, a microprocessor, an ASIC, a FPGA, a controller, and/or a microcontroller) and can be one processor or a plurality of processors that are operatively connected. The memory 754 can include one or more non-transitory computer-readable storage media, including RAM, ROM, EEPROM, EPROM, one or more memory devices, flash memory devices, and/or combinations thereof.

The memory 754 can store information that can be accessed by the one or more processors 752. For instance, the memory 754 (e.g., one or more non-transitory computer-readable storage mediums, memory devices) can store data 756 that can be obtained, received, accessed, written, manipulated, created, and/or stored. The data 756 can include, for instance, determining a state of a vehicle (e.g., the vehicle 108) and/or determining a state of an object inside the vehicle (e.g., a passenger of the vehicle) as described herein. In some implementations, the machine learning computing system 750 can obtain data from one or more memory devices that are remote from the system 750.

The memory 754 can also store computer-readable instructions 758 that can be executed by the one or more processors 752. The instructions 758 can be software written in any suitable programming language or can be implemented in hardware. Additionally, or alternatively, the instructions 758 can be executed in logically and/or virtually separate threads on the one or more processors 752.

For example, the memory 754 can store instructions 758 that when executed by the one or more processors 752 cause the one or more processors 752 to perform any of the operations and/or functions described herein, including, for example, determining a state of a vehicle (e.g., the vehicle 108) and/or determining ride experience data such as ride experience event detections and/or ride experience ratings associated with the event detections.

In some implementations, the machine learning computing system 750 includes one or more server computing devices. If the machine learning computing system 750 includes multiple server computing devices, such server computing devices can operate according to various computing architectures, including, for example, sequential computing architectures, parallel computing architectures, or some combination thereof.

In addition or alternatively to the one or more machine-learned models 730 at the computing system 710, the machine learning computing system 750 can include one or more machine-learned models 770. As examples, the one or more machine-learned models 770 can be or can otherwise include various machine-learned models including, for example, neural networks (e.g., deep convolutional neural networks), support vector machines, decision trees, ensemble models, k-nearest neighbors models, Bayesian networks, or other types of models including linear models and/or non-linear models. Example neural networks include feed-forward neural networks, recurrent neural networks (e.g., long short-term memory recurrent neural networks), convolutional neural networks, or other forms of neural networks. In some implementations, machine-learned models 770 can include a machine-learned ride experience model (e.g., machine-learned ride experience model 210 of FIG. 2).

As an example, the machine learning computing system 750 can communicate with the computing system 710 according to a client-server relationship. For example, the machine learning computing system 750 can implement the one or more machine-learned models 770 to provide a service to the computing system 710. For example, the service can provide determining ride experience data such as ride experience event detections and/or ride experience ratings associated with the event detections.

Thus the one or more machine-learned models 730 can located and used at the computing system 710 and/or the one or more machine-learned models 770 can be located and used at the machine learning computing system 750.

In some implementations, the machine learning computing system 750 and/or the computing system 710 can train the machine-learned models 730 and/or 770 through use of a model trainer 780. The model trainer 780 can train the machine-learned models 730 and/or 770 using one or more training or learning algorithms. One example training technique is backwards propagation of errors, such as discussed with reference to the method 600 of FIG. 10. In some implementations, the model trainer 780 can perform supervised training techniques using a set of labeled training data. In other implementations, the model trainer 780 can perform unsupervised training techniques using a set of unlabeled training data. The model trainer 780 can perform a number of generalization techniques to improve the generalization capability of the models being trained. Generalization techniques include weight decays, dropouts, or other techniques.

In particular, the model trainer 780 can train the one or more machine-learned models 730 and/or the one or more machine-learned models 770 based on a set of training data 782. The training data 782 can include, for example, a plurality of sensor data, a variety of facial expression samples, a variety of body pose samples, a variety of sound samples, representations of sensor data and corresponding labels that describe corresponding ride experience data, and/or the like. The model trainer 780 can be implemented in hardware, firmware, and/or software controlling one or more processors.

The computing system 710 can also include a network interface 720 used to communicate with one or more systems or devices, including systems or devices that are remotely located from the computing system 710. The network interface 720 can include any circuits, components, and/or software, for communicating with one or more networks (e.g., the network 740). In some implementations, the network interface 720 can include, for example, one or more of a communications controller, receiver, transceiver, transmitter, port, conductors, software, and/or hardware for communicating data. Similarly, the machine learning computing system 750 can include a network interface 760.

The networks 740 can be any type of network or combination of networks that allows for communication between devices. In some embodiments, the network 740 can include one or more of a local area network, wide area network, the Internet, secure network, cellular network, mesh network, peer-to-peer communication link, and/or some combination thereof, and can include any number of wired or wireless links. Communication over the network 740 can be accomplished, for instance, via a network interface using any type of protocol, protection scheme, encoding, format, and/or packaging.

FIG. 11 illustrates one example computing system 700 that can be used to implement the present disclosure. Other computing systems can be used as well. For example, in some implementations, the computing system 710 can include the model trainer 780 and the training dataset 782. In such implementations, the machine-learned models 730 can be both trained and used locally at the computing system 710. As another example, in some implementations, the computing system 710 is not connected to other computing systems.

In addition, components illustrated and/or discussed as being included in one of the computing systems 710 or 750 can instead be included in another of the computing systems 710 or 750. Such configurations can be implemented without deviating from the scope of the present disclosure. The use of computer-based systems allows for a great variety of possible configurations, combinations, and divisions of tasks and functionality between and among components. Computer-implemented operations can be performed on a single component or across multiple components. Computer-implemented tasks and/or operations can be performed sequentially or in parallel. Data and instructions can be stored in a single memory device or across multiple memory devices.

Computing tasks discussed herein as being performed at computing device(s) remote from the autonomous vehicle can instead be performed at the autonomous vehicle (e.g., via the vehicle computing system), or vice versa. Such configurations can be implemented without deviating from the scope of the present disclosure. The use of computer-based systems allows for a great variety of possible configurations, combinations, and divisions of tasks and functionality between and among components. Computer-implemented operations can be performed on a single component or across multiple components. Computer-implements tasks and/or operations can be performed sequentially or in parallel. Data and instructions can be stored in a single memory device or across multiple memory devices.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computer-implemented method, comprising:
receiving, by a computing system comprising one or more computing devices, sensor data from one or more sensors positioned within a cabin of a vehicle, the sensor data being descriptive of one or more passengers located within the cabin of the vehicle;
inputting, by the computing system, the sensor data to a machine-learned ride experience model;
receiving, by the computing system as an output of the machine-learned ride experience model, ride experience data including ride experience events detected from the sensor data and ride experience ratings classifying each detected ride experience event; and
determining, by the computing system and based on the ride experience rating for each detected ride experience event, a ride experience control signal associated with operation of the vehicle.

2. The computer-implemented method of claim 1, wherein the machine-learned ride experience model is configured to implement at least one of facial expression analysis and body pose analysis of the sensor data.

3. The computer-implemented method of claim 2, wherein the sensor data comprises image data from one or more image sensors positioned within the cabin of the vehicle and audio data from one or more audio sensors positioned within the cabin of the vehicle; and wherein the machine-learned ride experience model is configured to implement sound analysis of the audio data.

4. The computer-implemented method of claim 1, wherein the sensor data comprises image data from one or more image sensors positioned within the cabin of the vehicle; and
wherein the machine-learned ride experience model is configured to detect within the image data one or more passengers and one or more body parts associated with the one or more passengers located within the cabin of the vehicle; and
the machine-learned ride experience model is configured to implement facial expression analysis and body pose analysis of the sensor data relative to the one or more body parts detected within the image data.

5. The computer-implemented method of claim 4, wherein the machine-learned ride experience model is further configured to determine a body connection framework connecting multiple of the one or more body parts together and to implement body pose analysis by measuring relative movement of the body connection framework.

6. The computer-implemented method of claim 1, wherein the ride experience rating classifying each detected ride experience event is selected from a predetermined class comprising a good passenger experience rating and a bad passenger experience rating.

7. The computer-implemented method of claim 1, wherein the ride experience rating classifying each detected ride experience event is dynamically determined on a gradient scale within a range of possible values.

8. The computer-implemented method of claim 1, wherein the machine-learned ride experience model comprises a plurality of shared layers that are used at least in part for both determining facial expressions and determining body pose as part of determining ride experience data.

9. The computer-implemented method of claim 1, wherein the ride experience control signal comprises a vehicle control signal, wherein the vehicle control signal provides data that can be used for adjusting a motion plan of the vehicle based in part on the ride experience data.

10. The computer-implemented method of claim 1, wherein the ride experience control signal comprises a driving data log signal, wherein the driving data log signal triggers storage of data associated with a detected ride experience event that can be used to determine metrics associated with overall passenger ride experience.

11. The computer-implemented method of claim 1, wherein the ride experience control signal comprises a trip assistance signal, wherein the trip assistance signal includes a request to initiate two-way conversation with the vehicle for use in a determination of subsequent assistance steps.

12. A computing system, comprising:
one or more image sensors positioned within a cabin of a vehicle and configured to obtain image data being descriptive of an appearance of one or more passengers located within the cabin of the vehicle;
one or more processors;
a machine-learned ride experience model that has been trained to analyze the image data by implementing at least one of facial expression analysis and body pose analysis of the image data and to generate ride experience data in response to receipt of the image data; and
at least one tangible, non-transitory computer readable medium that stores instructions that, when executed by the one or more processors, cause the one or more processors to perform operations, the operations comprising:
providing real-time samples of the image data to the machine-learned ride experience model; and
receiving as an output of the machine-learned ride experience model, ride experience data including ride experience events detected from the image data and a classification for each detected ride experience event according to a ride experience rating.

13. The computing system of claim 12, further comprising one or more audio sensors positioned within a cabin of a vehicle and configured to obtain audio data descriptive of sound associated with one or more passengers located within the cabin of the vehicle; and wherein the machine-learned ride experience model has been trained to analyze the audio data as part of generating the ride experience data.

14. The computing system of claim 12, wherein the operations further comprise determining, based on the ride experience rating for each detected ride experience event, a ride experience control signal associated with operation of the vehicle.

15. The computing system of claim 12, wherein:
the machine-learned ride experience model is configured to detect one or more objects of interest within the image data, the one or more objects of interest including one or more body parts associated with the one or more passengers located within the cabin of the vehicle; and
the machine-learned ride experience model is configured to implement facial expression analysis and body pose analysis of the image data relative to the one or more body parts detected within the image data.

16. The computing system of claim 15, wherein the machine-learned ride experience model is further configured to determine a body connection framework connecting multiple of the one or more body parts together and to implement body pose analysis by measuring relative movement of the body connection framework.

17. An autonomous vehicle, comprising:
a sensor system comprising one or more image sensors and one or more audio sensors for obtaining respective image data and audio data associated with one or more passengers of an autonomous vehicle;
a vehicle computing system comprising:
one or more processors; and
at least one tangible, non-transitory computer readable medium that stores instructions that, when executed by the one or more processors, cause the one or more processors to perform operations, the operations comprising:
inputting the image data and audio data to a machine-learned ride experience model;
receiving, as an output of the machine-learned ride experience model, ride experience data including ride experience events detected from the image data and audio data and a classification for each detected ride experience event according to a ride experience rating; and
determining, based on the ride experience rating for each detected ride experience event, a ride experience control signal associated with operation of the vehicle.

18. The autonomous vehicle of claim 17, wherein the machine-learned ride experience model is configured to implement one or more of facial expression analysis of the image data, body pose analysis of the image data, and sound analysis of the audio data.

19. The autonomous vehicle of claim 17, wherein:
the machine-learned ride experience model is configured to detect one or more objects of interest within the image data, the one or more objects of interest including one or more body parts associated with the one or more passengers located within a cabin of the vehicle; and
the machine-learned ride experience model is configured to implement facial expression analysis and body pose analysis of the image data relative to the one or more body parts detected within the image data.

20. The autonomous vehicle of claim 19, wherein the machine-learned ride experience model is further configured to determine a body connection framework connecting multiple of the one or more body parts together and to implement body pose analysis by measuring relative movement of the body connection framework.
